(19) United States
(12) Patent Application Publication
(10) Pub. No.: US 2020/0378617 A1
(43) Pub. Date: Dec. 3, 2020

(54) System for Heating and Cooling a Room

(71) Applicant: Hall Labs LLC, Provo, UT (US)

(72) Inventors: David R Hall, Provo, UT (US); Arjun Krishna, Orem, UT (US); Benjamin Jensen, Orem, UT (US); Jeremy Johnson, Salem, UT (US)

(73) Assignee: Hall Labs LLC, Provo, UT (US)

(21) Appl. No.: 16/424,439

(22) Filed: May 28, 2019

(51) Int. Cl. F24D 3/14; F24D 3/18; H05B 1/02; F24F 3/06

(52) U.S. Cl. CPC F24D 3/14; F24D 3/18; F24F 2110/10; F24F 3/06; H05B 1/0297

(57) ABSTRACT

A system for heating and cooling a room including a layer of channels and a heating layer. The layer of channels allows a chilled fluid to pass through it while the heating layer has a resistor that is configured to turn electricity into heat.

### CROSS-REFERENCE TO RELATED APPLICATION

The present application is a Continuation-In-Part application of U.S. application Ser. No. 15/947,035, filed Apr. 6, 2018 and entitled “Hydronic Panel.” The entire disclosure of the prior application is incorporated herein by reference.

### TECHNICAL FIELD

The present invention relates to radiant heating and cooling devices.

### BACKGROUND

Various solutions exist for heating and cooling spaces. Heating can be provided to a complete building, such as a residence, by a furnace that heats air, e.g. by combustion of a gas, which heated air is blown through vents into the building. Also, a boiler can heat water, oil, or other fluids, which circulate through pipes or radiators to heat rooms with radiant heat. Alternatively, electrical heaters can convert electricity to heat. Similarly, cooling can be provided with forced central air, chilled fluids that are pumped through pipes or radiators, and local electrical air conditioners.

Typical radiant heating systems are often standalone units or are installed in floors. Sometimes, they are also installed in walls and ceilings. Some more recent radiant heating systems use PEX (cross-linked polyethylene) pipes or other types of pipes that are placed throughout the floor, wall, or ceiling, and water circulates through the pipes to either heat or cool the surrounding space. However, when the pipes in which the water circulates cover a small portion of the surface area where they are installed, such radiant heating systems may result in slow or uneven heating, especially when objects such as couches, bookshelves, pictures, or clocks are placed in front of or over the top of the system. Furthermore, such systems can be difficult to construct, install, or repair.

### SUMMARY

In a first aspect, a system for heating and cooling a room including a layer of channels and a heating layer is disclosed. The layer of channels allows a fluid to pass through it while the heating layer has a resistor that is configured to turn electricity into heat.

In a second aspect, a radiant heat exchange system comprising a panel which includes an array of contiguous tubular vessels is disclosed. The panel has a front side that faces a room and a back side that faces a wall. The system also includes a heater comprising an electrothermal resistor, which is planar in shape and is disposed along front side of the panel.

In a third aspect, a system for changing the temperature within a room comprising a layer of channels made from a sheet of extruded plastic, a pump, and a heating layer is disclosed. The system also includes a thermometer configured to sense a temperature in the room. It further includes an actuator configured to turn the pump on when the thermometer senses a temperature above a predetermined number and to turn the heater on when the thermometer senses a temperature below a predetermined number.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is perspective view of a system for heating or cooling a room according to one embodiment of the invention including two panels and a thermostat.

FIG. 2 is a perspective view of a system for heating or cooling a room including an electric heater and a chiller.

FIG. 3 is a front elevation view of a system for heating or cooling a room according to another embodiment of the invention including a geothermal heat pump.

FIG. 4 is a rear elevation view of another embodiment of the invention including an air heat pump on the outside wall of a radiant panel.

FIGS. 5a-5c are perspective views of embodiments of the invention using various layers of channels.

FIG. 6 is a perspective view of one embodiment of the invention including a vacuum layer.

FIG. 7 is a front view of one embodiment of the invention wherein the channels are grouped into zones with the use of plugs.

FIG. 8 is a perspective view of one embodiment of the invention including spacing elements.

FIG. 9 is a side view of another embodiment of the invention including spacing elements.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “contiguous,” as in “contiguous channels,” is generally meant to refer to the channels being separated by a common wall, although the key feature is that the channels are adjacent to each other.

As used herein, “chilled,” “cold” or “cooled,” as in “chilled fluid” “cold fluid” or “cooled fluid,” is meant to refer to fluid that is generally below the ambient temperature of the room.

As used herein, “radiant area” is defined as the total cross-sectional area of the cooled fluid in the plane parallel to the surface of the wall. For example, if an array of circular pipes containing cooled fluid was in a wall, the radiant area would be total length of pipe in the wall, times its diameter. Radiant area does not include transport piping or area of fluid outside the room being heated or cooled.

As used herein, “exchange medium” means matter which is an energy sink or an energy source depending on the needs of the system. For example, an exchange medium could comprise earth, air, water, refrigerant, etc. “Exchange medium” only refers to mediums of forced exchange rather than downstream uncontrolled energy exchange.

As used herein, a “closed system” means a system of piping, channels, or other fluid containing tubular vessels which primarily reuses the same fluid rather than introducing new fluid during use of the system.

As used herein, “continuously-parallel circuit” is meant to refer to a circuit comprising two conductors disposed along the edge of a resistor such that an increased length of the resistor adds to the resistance in parallel, or in other words, reduces the overall resistance.

As used herein, the term “panel” is to be given a relatively broad meaning, referring to a component that has a depth smaller than the height and width. Preferably, the panels in this invention are flat and rectangular. Nevertheless, the panels may also be curved, bent and have shapes other than rectangles. Panel may refer to one portion of a prebuilt wall, or it may refer to one portion of a wall that is built in place.

As used herein, “thermal communication” refers to the exchange of energy between components, whether it be by conduction, convection, or radiation.

Unless otherwise noted, temperatures are given in degrees Fahrenheit.

As used herein, “electrothermal” refers to the generation of heat from electricity.

Radiant heating, as opposed to convective heating, is popular due to its quiet nature and the fact that it does not spread allergens. It can also be more efficient than convective heating because it does not require heating up the air of the building before a user can feel the warmth. Similarly, radiant cooling, although not as popular as radiant heating, is a quiet, efficient, and nondisruptive way to cool a building. Radiant panels can be configured to run in a cooling mode when cooler temperatures are desired and a heating mode when warmer temperatures are desired.

Radiation is transferring electromagnetic energy in the form of infrared rays from one surface to the other surfaces around it. The amount of energy transferred depends on both the temperature and area of the surface. A higher temperature and a larger surface area will increase heat transfer. Therefore, it is beneficial to increase the temperature and the surface area of a radiant heater. Or conversely, increasing the surface area can allow a radiant heater to operate at cooler temperatures, which may be useful when a source of heat is not hot enough to operate with a smaller surface area. It also can be safer. Similarly, a larger area for a radiative cooler can absorb more energy from the room as the objects in the room radiate to it, helping the room to cool down more quickly.

In accordance with the present invention, the system includes a panel with at least two layers: one for heating and one for cooling. The preferred embodiment includes an electric heating layer, which uses a resistor to convert electricity to heat, and a hydronic cooling layer, which moves a cooled fluid over a large surface area in order to absorb heat. The layers may be different shapes or sizes within the panel, but ideally are both substantially the same size and shape of the panel in order to maximize the radiant heating and cooling effect.

One embodiment of this aspect of the invention comprises a heating layer that has an elongated resistor or series of resistors that weave back and forth or in a fashion that mimics a solid or near solid sheet. This type of heater is similar to the heating lines in the rear window of a vehicle, although ideally they are closer together. In another embodiment of the invention, the heating layer comprises a continuous sheet of resistive film with electrical conductors along both sides of the film, which puts the resistive film in a continuously-parallel circuit. One example is defined in US patent publication US 2016/0185983 A1, which is hereby incorporated into this application. A continuously-parallel circuit has the benefit of adding additional length of resistive film in parallel rather than in series, which allows more flexibility for sizing the heater for different applications.

Similarly, the surface area of the cooling layer is maximized to aid heat transfer. In one embodiment, the area of a radiant cooler is maximized by running cooled fluid through a panel made primarily of channels for fluid. One example is an extruded plastic panel of rectangle channels commonly called “twinwall” or “plastic cardboard.” The channels may be contiguous such that each channel shares a wall, or partition, with an adjacent channel. This way, most or all of the area of the panel is radiant area. This provides much more radiant area than a panel or wall with traditional pipes running through it. It also minimizes leaking and maintenance because fluid from a leaky channel may go into the adjacent channel. In some embodiments, the radiant area is preferably greater than 20% of the wall. Even more preferably, the radiant area is greater than 50% of the wall. Even more preferably, the radiant area is more than 90% of the wall. The greater the radiant area is, the smaller the temperature differential between the heating or cooling fluid and the room needs to be.

The fluid used in the system to transfer energy into or out of the room could be any fluid that is not harmful to the system, including gases or liquids. Liquids, such as water, have many ideal characteristics, such as high emissivity, high specific heat, and low cost. However, water tends to allow growth of organisms and has the potential of freezing. Glycols, such as ethylene glycol or propylene glycol, are commonly added to water to bring the freezing point down and prevent growth of organisms. However, glycol reduces the specific heat of the mixture, so more volume is required through the system than with water alone. There are many glycols which share similar physical properties and are suitable for use in the invention, but the preferred embodiment typically uses propylene glycol because it is non-toxic and safer if there is a leak or spill. Preferably, the fluid is a water mixture with 20% to 45% glycol. Even more preferably, the fluid is a water mixture with 25% to 40% glycol. Even more preferably, the fluid is a water mixture with 30% to 32% glycol.

One benefit of the present invention is that fluid may pass through the panel in a plurality of ways. In one embodiment, the fluid may flow up one channel and down the next, repeating through the channels from one side of the panel to the other. In another embodiment, the channels may be grouped into zones wherein the fluid passes up two or more channels, and then down two or more channels, repeating through the channels from one side of the panel to the other in a serpentine fashion. Additionally, the fluid may travel the same way through all the channels, such as from top to bottom. In yet another embodiment of the invention, the fluid passes from one side to the other side through any configuration of channels, but then returns to the first side typically through a top or bottom channel. In that embodiment the fluid may never leave the panel, but will cycle through it. In others, the fluid enters the panel through an inlet and exits through an outlet where it is directed to another part of the heating or cooling process.

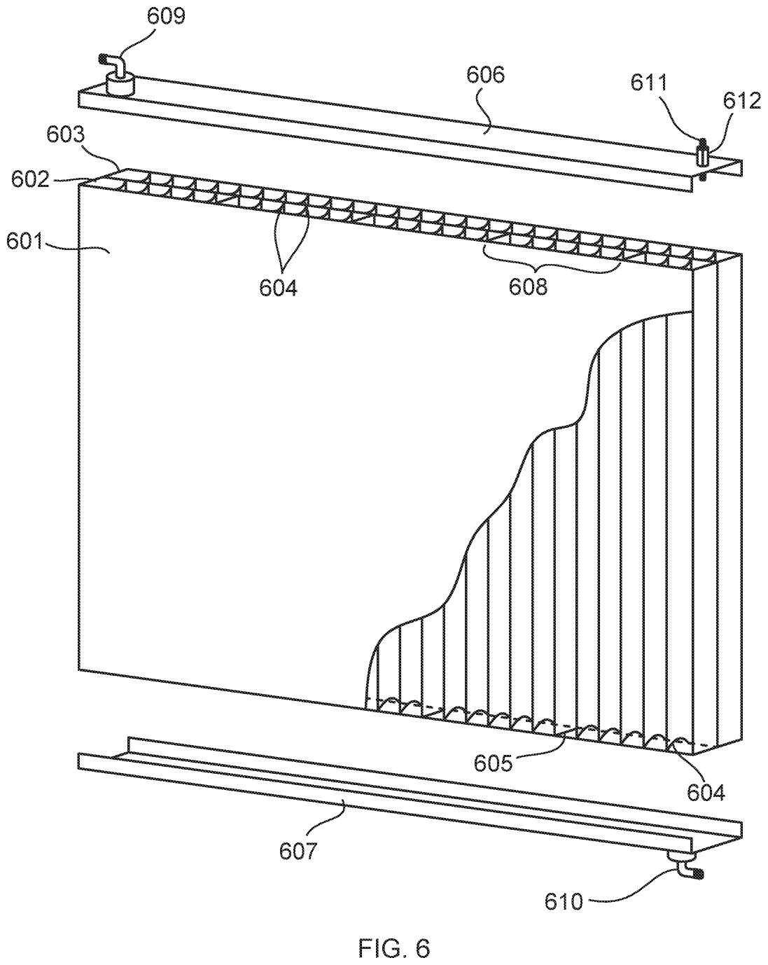

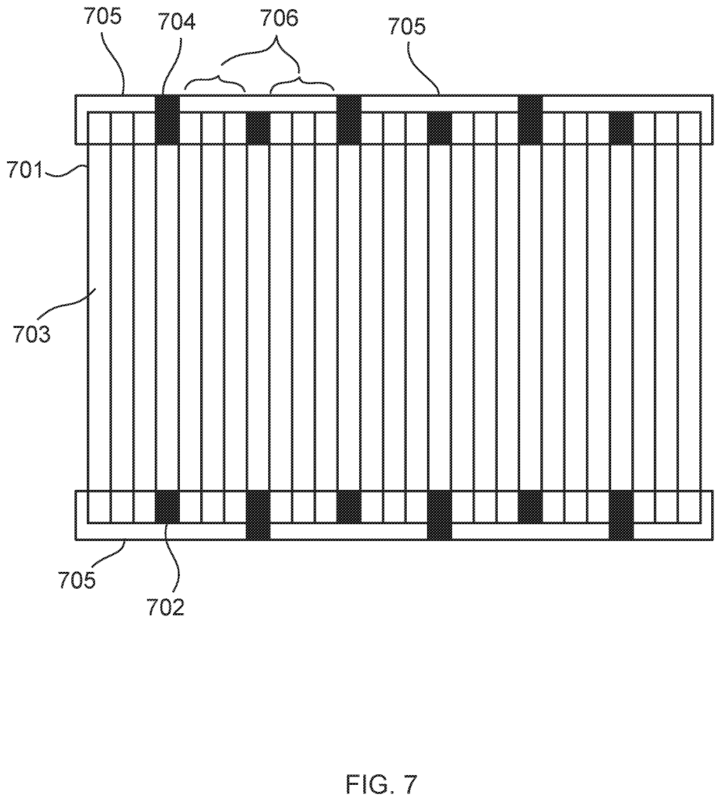

The panel may be divided into zones in many ways. In one embodiment of the invention, one or more channels may have a notch or carveout of a section of a partition dividing it from another channel which puts two channels in fluid communication with each other. Many channels can be formed into a zone with neighboring carved-out partitions between channels. See FIG. 6 below for an example of carved-out partitions. Another way is with an endcap placed over an open end of a panel that puts some channels in communication with each other while blocking off others. In that configuration, there may be an opposing and corresponding endcap configured to provide the same zones as depicted in FIG. 7.

To prevent fluid from leaving the panel, some embodiments of the invention include an endcap. The endcap covers an open end of the channel. In some embodiments, the endcap is configured to redirect fluid from one channel or zone into another channel or zone. In one embodiment, the endcap is a manifold which distributes the fluid into more than one channels or zones.

The invention may also comprise an open or closed type system. In one embodiment, the fluid is in a closed system, wherein fluid is not added to the system except to replace fluid lost during maintenance or leaks. In another embodiment, the fluid is in an open system, wherein fluid is constantly added and disposed of during operation, such as fluid from a domestic water supply, secondary water supply, or an aquifer.

In one embodiment, the fluid is in communication with a heat pump. The heat pump exchanges energy between the fluid and an exchange medium, typically a compressible fluid capable of conducting heat such as a refrigerant. In some embodiments, that exchange medium is configured to transfer energy to another exchange medium, such as the air around a heat pump, or the earth around geothermal piping. In other embodiments, there is an additional exchange medium, such as when energy is transferred from the fluid to a refrigerant and from the refrigerant to an antifreeze all within a heat pump, and then that antifreeze is then pumped into geothermal piping where energy is finally exchanged with subterranean earth. In some embodiments, a heat pump is on the exterior of a building, which helps separate the exchange medium from the heated or cooled room, especially if the exchange medium is air. A heat pump on an exterior of a building has the added flexibility of being able to be plugged in to an internal or external outlet.

The invention also provides flexible installation options, including covering options. In one embodiment, the panel includes a finishable surface, such the fibrous surface of drywall. In other embodiments, the panel includes a decorative surface, such as a wallpaper or a painted surface. All of such options will help to make the panel's appearance unnoticeable. In other embodiments, it has a no covering or only a thin decorative covering to reduce the amount of heat absorbed by the wall. A thin decorative covering may be traditional paint, wallpaper, or canvas, which itself may have a painted or printed image. The decorative covering preferably also has a has a low thermal conductivity but a high emissivity, such as a velvet wallpaper, in order to make the wall cooler to the touch while still warming the room through radiation.

In other embodiments, the panel has a layer of insulation, typically on the back side, either to reduce heat transfer through the wall or to reduce noise, or both. Insulation could be traditional fiberglass or foamboard, or it could comprise a second channel layer configured to insulate. In one embodiment, one or more additional channel layers, preferably made of twinwall, may be used and is filled with sound damping material such as soil or barite. In other embodiments, additional channel layers may be used with a layer of air to discourage sound vibrations and heat transfer.

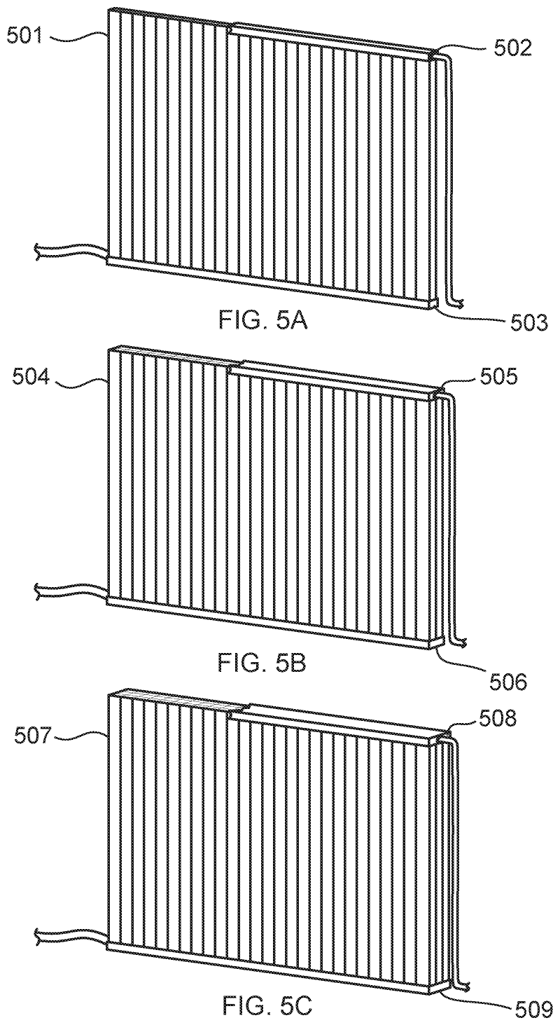

One embodiment of the invention utilizes multiple channel layers configured to aid insulation, noise reduction, or reduce condensation by pulling a vacuum in one of the layers. This is possible by using multiple sheets of extruded material which are placed adjacent to each other or a single panel of extruded material which has multiple channel layers within it. Channels of air make great insulators, but channels with a vacuum are better because there is no convection or conduction through an empty space. One embodiment of the invention has a single panel with three channel layers, as depicted in FIG. 5c. Cooled fluid may run through the layer closest to the room to receive heat from the room, and the middle or rear layer would have a vacuum. The third layer may also have a vacuum to serve as an additional insulative layer. It also could be filled with air or an insulator, such as barite, or it could be a second fluid containing layer. In the preferred embodiment of this configuration, the vacuum layer is on the front and the fluid-containing layer is in the middle or back. This could drive radiation as the main heat transfer mechanism. In some cases, this may help with condensation on the front of the wall, especially during cooling. This is because the temperature of the front of the panel will be somewhere between the temperatures of the fluid layer and the room, especially if its temperature is closer to room temperature.

The invention can be versatilely installed into the structure of a home. It can simply replace drywall and be supported by a support structure, such as wooden studs, or it can comprise a structural layer, such as a layer of sheet metal, and support the building. In one embodiment of the invention, a single panel is installed in a room. In other embodiments, more than one panel can be connected with fluid communication between the panels, which will increase the radiant area. In yet other embodiments, the panels make up the majority or the entire wall structure of the home. In yet other embodiments, the panels are configured to be retrofit into established buildings.

In addition to being installed into the structure of the home, the panels may be prefabricated-standalone panels. In one embodiment, the panel is fixed to the outside of a preexisting wall, but in others it supports itself either by leaning against a wall or with its own support structure, or hung like a decorative item. The prefabricated wall may be entirely mobile, such that it contains its own heating or cooling source, or it may connect to the home's preexisting heating or cooling systems such as HVAC, air conditioning, or radiative piping.

The invention may be configured in a way that provides cooling utilizing the fluid and channel layer but heating with a separate heater that does not use the fluid. This may be needed when a home has access to cooled water, such as from an aquifer or secondary water. In one embodiment of the invention, the panel is connected to a source of cooled water for when it is in cooling mode and has a separate heating layer configured to heat the room when it is in heating mode.

Another embodiment of the invention uses a reflective layer disposed within the panel to help direct heat transfer in a particular direction. Materials with very low emissivity (ability to radiate energy), such as aluminum, brass, chromium, or silver, among others, may be placed on the back side of the panel in order to reduce radiation into the wall. In the preferred embodiment, a reflective layer will have an emissivity lower than 0.1 and be economically sourced, such as aluminum foil with an emissivity of 0.04.

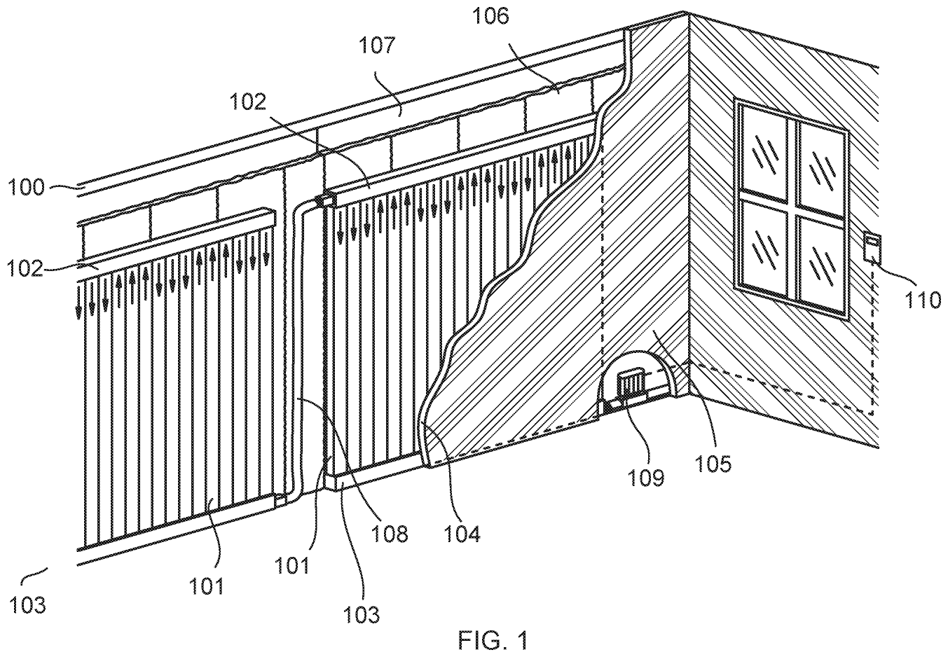

Now referring to FIG. 1, one embodiment of a radiant heating and cooling system is shown 100. A cooling layer 101 comprises a layer of contiguous channels, which are filled with a fluid which can be cooled. The channels may be configured into zones such that fluid travels the same direction through each zone rather than alternating each adjacent channel. In the depicted embodiment, fluid is supplied to three channels through an upper manifold 102, and then redirected into the next three channels through a lower manifold 103. The upper manifold 102 and lower manifold 103 also serve to redirect the fluid through the rest of panel, where it finally exits the panel through the lower manifold 103.

In the depicted embodiment, the panel 101 is covered with a sheet of drywall 104, which is covered with a layer of wallpaper, 105. A heating element 106 is behind the cooling layer 101. In this embodiment, the heating element is an elongated resistor shaped in a serpentine configuration to maximize a rectangular surface area. Insulation 107 is placed behind the heating layer 106 in order to prevent heat loss into the wall. A layer of low-emissive material, such as foil 108, is placed behind the insulation 107 to prevent radiation through the back side of the wall.

The embodiment of FIG. 1 shows two panels in series, wherein interconnected piping 109 puts the two panels in fluid communication. A pump 110 forces fluid either to or from the panels. In the depicted embodiment, the pump is actuated by a thermostat 111. In this embodiment but not shown in FIG. 1, the piping would also connect to a cooler.

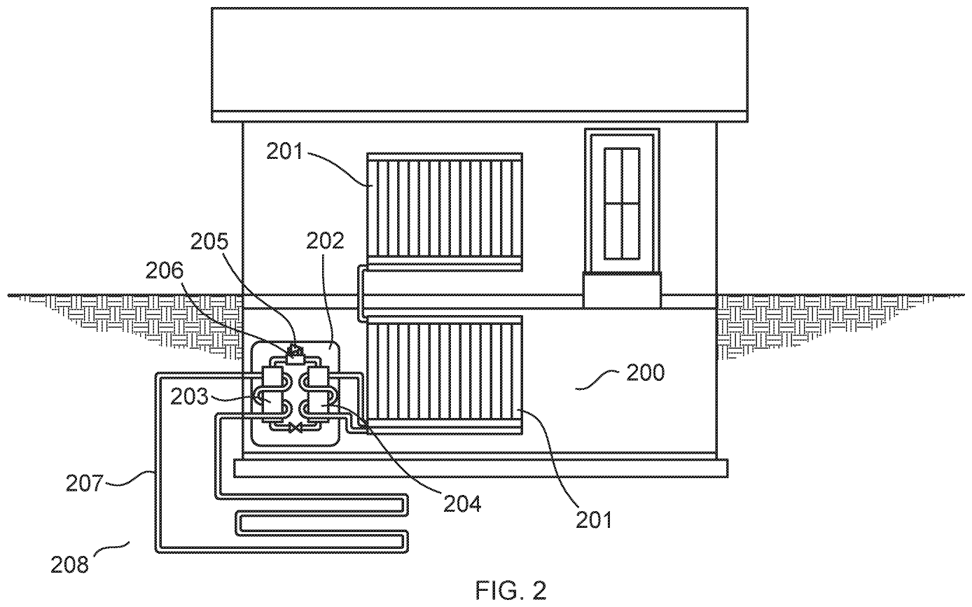

Now referring to FIG. 2, which is an embodiment of the invention that includes a heating layer in a continuously-parallel circuit 201, and a cooling layer 202. The heater 201 is powered by an outlet 203. In the depicted embodiment, the heating layer is on the front side of the channel layer, however, in other embodiments the channel layer is on the front.

The depicted embodiment shows a window-mounted chiller 204, but cooled water supply may be other sources such as an aquifer, secondary water, geothermal piping, or other. Here, the chiller is in fluid communication with the channel layer through two interconnecting pipes 205.

In the preferred embodiment, the chiller and heater are controlled by a thermostat 206. The thermostat 206 can be programmed to turn on the chiller when it senses the room is above a predetermined temperature and turn on the heater when it senses the room is below a predetermined temperature. In other embodiments, the chiller and the heater have manual switches or have separate thermostats.

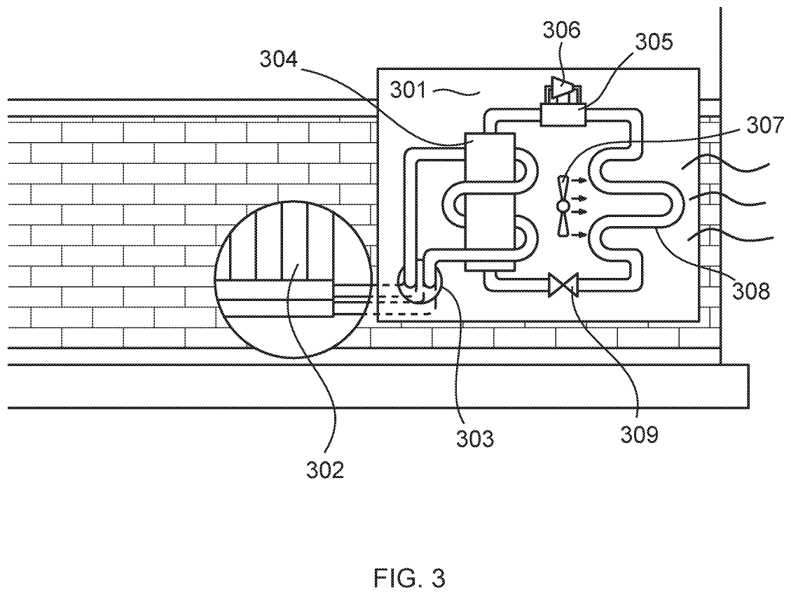

Now referring to FIG. 3, a radiant heating and cooling system 300 is shown. A radiant panel containing fluid 301 is disposed inside of a room. The panel is in fluid communication with a heat pump 302. The heat pump comprises an evaporator 303 and a condenser 304. The heat pump also includes a compressor 305. Geothermal piping 307 is in thermal communication with both the heat pump 302 and subterranean earth 308. In cooling mode, the heat pump 302 exchanges energy from the fluid of the radiant panel 301 to the fluid of the geothermal piping 307. It uses the subterranean earth 308 as a heat sink to absorb that energy before returning to the heat pump 302 to receive more heat. In the depicted embodiment, the heat pump 302 uses an indirect exchange geothermal system, which means a refrigerant is an intermediary between the fluid of the radiant panel and the fluid of the geothermal piping and transfers heat between the two systems of piping. In that embodiment, the fluid in the geothermal piping may be an antifreeze such as glycol, methanol, water, a mixture thereof, or other. In another embodiment, such as a direct exchange geothermal system, there is no intermediary fluid. In that embodiment, a refrigerant is typically piped through the heat pump and then directly into the ground to exchange heat with the subterranean earth. Not shown in FIG. 3 is a heating layer.

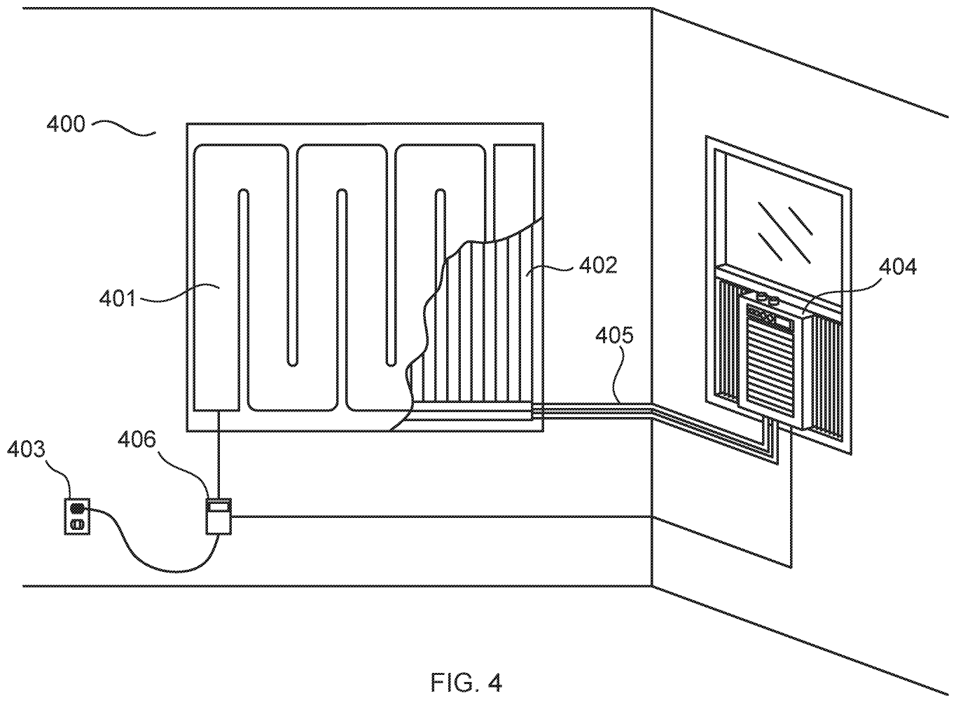

Now referring to FIG. 4, which is one embodiment of the invention wherein a heat pump 401 is outside of a room with a radiant panel 402. This embodiment is configured to simplify piping between the radiant panel 402 and the heat pump 401, with only one or a few small holes in the building 403. The fluid in the radiant panel exchanges energy with the heat pump through a heat exchanger 404. The heat pump also contains a reversing valve 405 and a compressor 406. A fan 407 blows air over another heat exchanger 408. The system also contains an expansion valve 409, which cools the refrigerant by expanding it.

Now referring to FIG. 5, which shows multiple embodiments of the invention. FIG. 5A shows a radiant panel with a single row of channels 501. Endcaps 502 and 503 keep fluid from escaping the panel. FIG. 5B shows a radiant panel with two rows of channels 504. Endcaps 505 and 506 keep fluid from escaping the panel. FIG. 5C shows a radiant panel with three rows of channels 507. Endcaps 508 and 509 keep fluid from escaping the panel.

Now referring to FIG. 6, which shows an embodiment of the invention with a vacuum layer. A radiant panel 601 has two rows of channels, each comprising a different layer of the panel: a fluid layer 602 and a vacuum layer 603. Some of the partitions of the fluid layer have a notch 604 allowing fluid to flow between them, while others extend to the end of the channel 605 to form a barrier between the partition and the endcaps 606 and 607. This allows a fluid to flow in the same direction through multiple channels, or zones 608. In this embodiment, the vacuum layer does not have any zones. A fluid inlet 609 and outlet 610 are on the endcaps and allow fluid to enter and exit the fluid layer. A vacuum nozzle 611 with check valve 612 is mounted on endcap 606 on the side of the vacuum layer, which allows air to be removed from the vacuum layer without reentering.

Now referring to FIG. 7, which shows one embodiment of the invention using plugs to create zones. A radiant panel 701 is shown in a serpentine configuration. Smaller plugs 702 prevent fluid from entering a channel 703, while larger plugs 704 prevent fluid from entering a channel and also passing through the endcaps 705. Zones 706 are created, in this case, each with three channels. The small and large plugs are offset such that fluid flows from side to side in a serpentine configuration through the panel. In this configuration, the endcaps 705 create manifold areas 706 that redirect the fluid back into the channels in contrast to FIG. 6, which uses notches within the channels to do this.

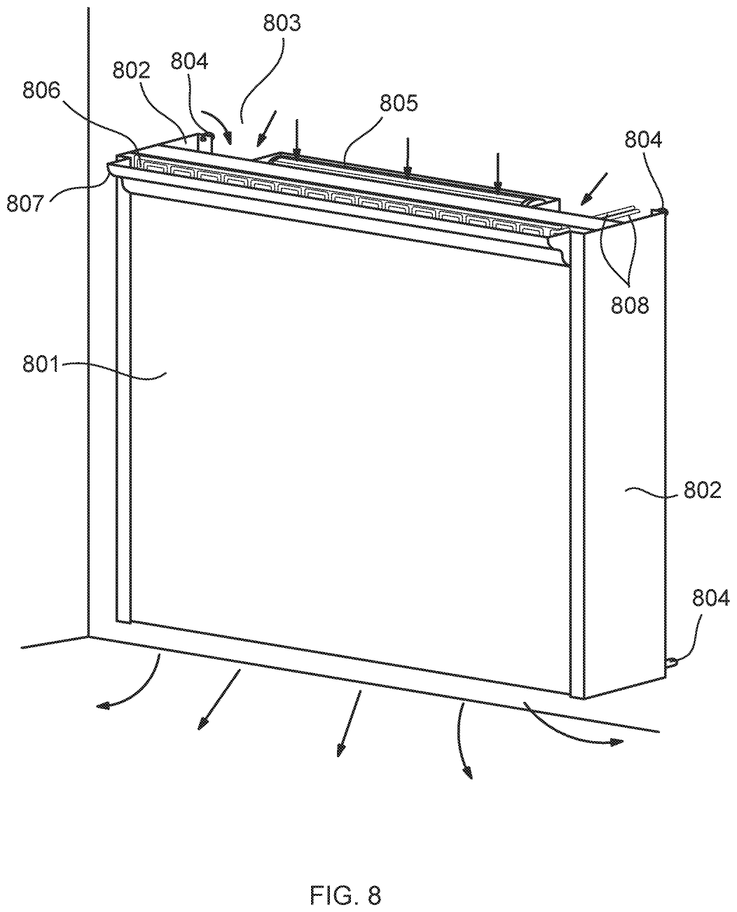

Now referring to FIG. 8, a heating and cooling system is depicted with a gap between a panel and a wall to allow airflow. A radiant panel 801 is attached to a wall with two mounting brackets 802. The mounting brackets 802 are also spacers which create an air-channel 803 between the wall and the panel 801. The system further includes sound damping spacers 804 to reduce sound propagation to or from the wall. A fan 805 may help air flow and energy transfer to or from the room as well as help remove condensation from the panel. In the preferred embodiment, the fan is a low rpm squirrel-cage fan, however, other fans such as propeller fans may also be used.

FIG. 8 also depicts a heat exchange chamber 806, which is hidden by a decorative crown molding 807. Within the heat exchange chamber 806, pipes 808 connecting to a cooling system (not shown) are in thermal communication with the fluid of the radiant panel 801 within the heat exchange chamber 806.

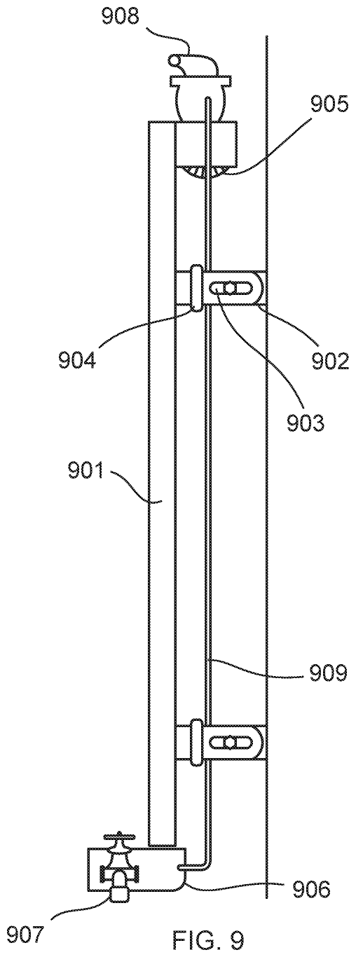

FIG. 9 shows another embodiment of the invention with spacers, which allow the panel to be offset from a wall. A radiant panel 901 is attached to a wall with spacers 902 with adjustable slots 903. The spacers 902 also include a sound damping rubber portion 904 to reduce sound propagation to or from the wall. A fan 905 may help air flow and energy transfer to or from the room as well as help remove condensation from the panel.

FIG. 9 further includes a condensation catching and returning system. A basin 906 is attached to the bottom of the system to catch condensation that drips down the panel 901. A spout 907 allows water to be removed from the basin 906. An additional method of draining the basin is with a humidifier 908. The humidifier is typically an ultrasonic or impeller type for cooling applications and a steam vaporizer for heating applications, although it may be any type that returns the condensation to the air. A water line 909 connects the basin 906 to the humidifier 908. The humidifier 908 has an additional supply line of water (not shown) in case humidity is desired when the basin 906 is empty.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for heating and cooling a room comprising:
a channel layer comprising a first and a second outer surface and a plurality of adjoined waterproof channels disposed therebetween, each channel configured to pass chilled fluid through when the system is in a cooling mode; and
a heating layer comprising a resistor configured to turn electricity into heat when in a heating mode.

2. The invention of claim 1 further comprising a chilling device for chilling the fluid.

3. The invention of claim 2 wherein the fluid is chilled to a temperature less than 50 degrees.

4. The invention of claim 2 wherein the chilling device is a heat pump configured to transfer energy in the fluid to an exchange medium.

5. The invention of claim 1 wherein the fluid comprises water and glycol.

6. The invention of claim 5 wherein the fluid comprises between 25% and 40% glycol.

7. The invention of claim 5 wherein the fluid comprises between 30% and 32% glycol.

8. The invention of claim 1 wherein the chilled fluid is sourced from a domestic water supply.

9. The invention of claim 1 wherein the chilled fluid is sourced from an aquifer.

10. The invention of claim 1 further comprising a thermostat configured to turn the heating layer on and off to maintain a predetermined temperature range.

11. The invention of claim 1 wherein the resistor is a resistive film.

12. The invention of claim 11 wherein the heating layer comprises a continuously-parallel circuit.

13. The invention of claim 11 wherein the heating layer is adjacent to a side of the channel layer facing away from the room, and wherein the heating layer heats the fluid in the channel layer to provide radiant heat for the room.

14. The invention of claim 1 wherein the radiant area of the channel layer is greater than 50% of the area of a wall on which it is installed.

15. A radiant heat exchange system comprising:
a panel comprising an array of contiguous tubular vessels configured to receive a fluid, the panel having a front side configured to face a room and a back side configured to face a wall;
a heater comprising an electrothermal resistor configured to receive electricity, the heater having a planar shape, and;
wherein the heater is fixed to the front side of the panel.

16. The invention of claim 15 wherein the electrothermal resistor is in a continuously-parallel circuit.

17. The invention of claim 15 further comprising a reflective layer on the back side of the system.

18. A system for changing the temperature within a room comprising:
a channel layer comprising a sheet of extruded plastic containing an array of adjacent channels;
a pump configured to move a fluid comprising water and glycol through the channels;
a heating layer adjacent a wall of the channel layer facing away from the room and comprising a resistor configured to turn electricity into heat, thus heating the fluid and thereby heating the room;
a thermometer configured to sense a temperature in the room; and
an actuator configured to turn on the pump when the thermometer senses a temperature above a predetermined number, and to turn on the heater when the thermometer senses a temperature below a predetermined number.

19. The invention of claim 18 wherein the heater is an electrothermal resistor in a continuously-parallel circuit.

20. The invention of claim 18 further comprising an insulative layer and a decorative layer, wherein the insulative layer is on a wall-side of the system and the decorative layer is on a front-side of the system.
